(19) United States
(12) Patent Application Publication
(10) Pub. No.: US 2009/0268164 A1
(43) Pub. Date: Oct. 29, 2009

(54) DOCKABLE MULTIMEDIA PROJECTION SYSTEM

(76) Inventors: Upton Beall Bowden, Canton, MI (US); Theodore Charles Wingrove, Canton, MI (US); Royce Duchante' Channey, Ann Arbor, MI (US)

Correspondence Address: FRASER CLEMENS MARTIN & MILLER LLC, 28366 KENSINGTON LANE, PERRYSBURG, OH, 43551, US

(21) Appl. No.: 12/110,433

(22) Filed: Apr. 28, 2008

(51) Int. Cl. G03B 21/14; G03B 21/58

(52) U.S. Cl. 353/13

(57) ABSTRACT

A projector system for a vehicle that provides an integrated docking system throughout the vehicle, thereby providing a passenger with a multimedia display in a variety of locations, wherein a temperature range over which the projector system performs is maximized, is disclosed. The projection system includes, a docking device integrated with a surface of the vehicle, wherein the docking device is in electrical communication with at least one secondary device. A projector is adapted to be coupled to the docking device, wherein the docking device provides electrical communication between the projector and the secondary device. A retracting device having a viewing screen adapted to display a projected video output of the projector is integrated with a surface of the vehicle. The retracting device is adapted to extend the viewing screen to display the projected video output of the projector and retract the viewing screen for storage.

### FIELD OF THE INVENTION

The invention relates to multimedia projection systems. More particularly, the invention is directed to a dockable multimedia projection system for a vehicle.

### BACKGROUND OF THE INVENTION

Current vehicles are limited in an ability to display video and multimedia sources. Most current vehicles use Liquid Crystal Displays (LCD) or some other form of flat-panel display to show video and other multimedia information. These displays are not flexible and do not perform well at cold temperatures. These displays are typically packaged in the back of seat headrests, floor consoles or roof- mounted applications. In general, the mounting location of these displays limits the size of the physical display.

It would be desirable to have a projector system for a vehicle that provides an integrated docking system throughout the vehicle, thereby providing a passenger with a multimedia display in a variety of locations, wherein a temperature range over which the projector system performs is maximized.

### SUMMARY OF THE INVENTION

Concordant and consistent with the present invention, a projector system for a vehicle that provides an integrated docking system throughout the vehicle, thereby providing a passenger with a multimedia display in a variety of locations, wherein a temperature range over which the projector system performs is maximized, has surprisingly been discovered.

In one embodiment, a projection system for a vehicle comprises a docking device integrated with a surface of the vehicle, wherein the docking device is in electrical communication with at least one secondary device, and a miniature LED-based projector adapted to be coupled to the docking device, wherein the docking device provides electrical communication between the projector and the secondary device.

In another embodiment, a projection system for a vehicle comprises a docking device integrated with a surface of the vehicle, wherein the docking device is in electrical communication with at least one secondary device, a projector adapted to be coupled to the docking device, wherein the docking device provides electrical communication between the projector and the secondary device, and a viewing screen adapted to display a projected video output of the projector.

In another embodiment, a projection system for a vehicle comprises a docking device integrated with a surface of the vehicle, wherein the docking device is in electrical communication with at least one secondary device, a projector adapted to be coupled to the docking device, wherein the docking device provides electrical communication between the projector and the secondary device, and a retracting device coupled to a vehicle surface, the retracting device including a retractable viewing screen adapted to display a projected video output of the projector.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a perspective view of a projection system according to an embodiment of the present invention showing the projection system undocked;

FIG. 2 is a perspective view of the projection system of FIG. 1 showing the projection system docked;

FIG. 3 is a perspective view of a projection system in cooperation with a viewing screen according to another embodiment of the present invention;

FIG. 4 is a perspective view of the projection system of FIG. 3 showing the viewing screen in use; and

FIG. 5 is a perspective view of the projection system of FIG. 3 showing a further use of the viewing screen.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

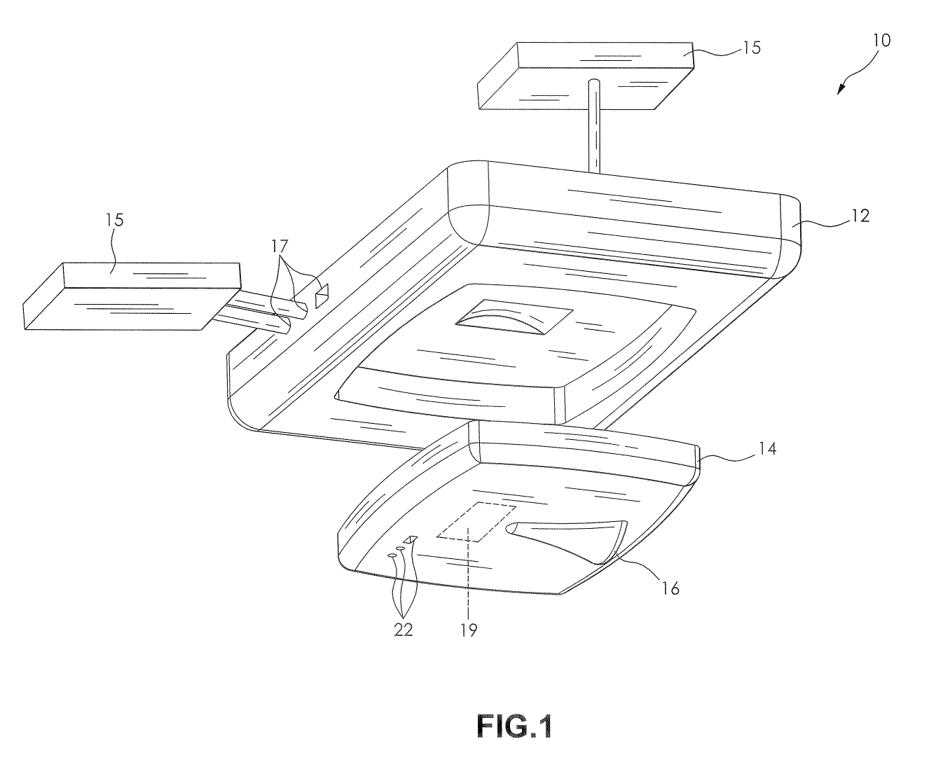

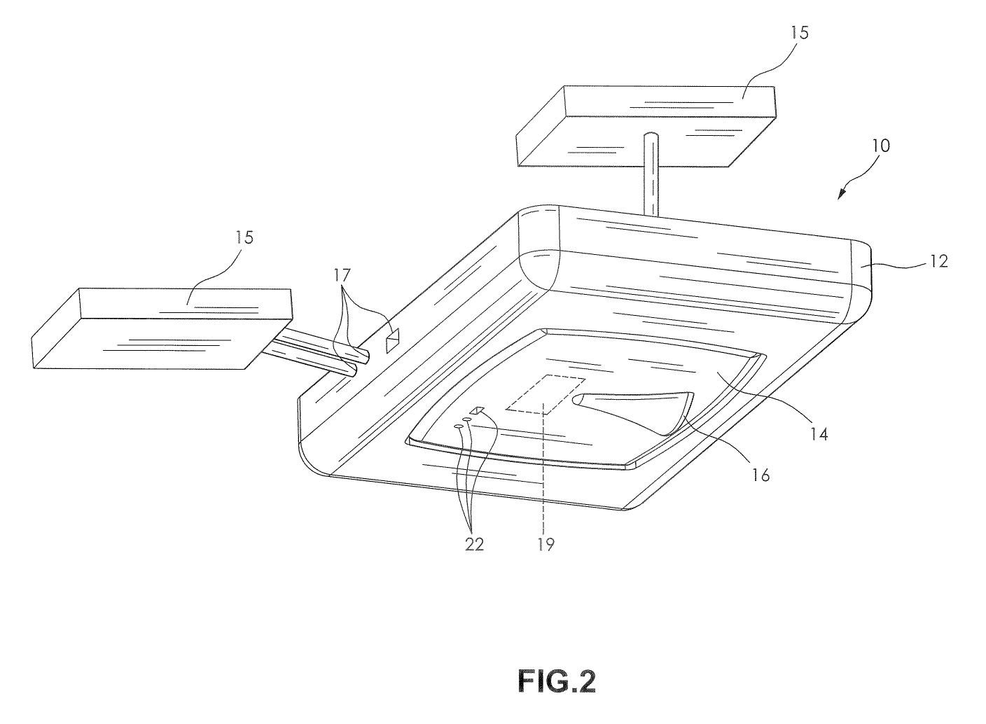

FIGS. 1 and 2 show a projector system 10 according to an embodiment of the present invention. The projector system 10 includes a docking device 12 and a projector 14. The docking device 12 is integrated with a desired surface of a vehicle (not shown). It is understood that the docking device 12 may be integrated with the desired surface by at least one of a manufacturing process and a mounting process during post-manufacturing installation, for example. Other integrating processes may be used, as desired. It is further understood that any number of docking devices 12 may be integrated with various vehicle surfaces. As a non-limiting example, a vehicle may be manufactured with multiple docking devices 12, each docking device 12 disposed at a pre-determined location on a vehicle surface. The docking device 12 is adapted to receive the projector 14 and mechanically secure the projector 14 to the desired surface. It is understood that any conventional means of selectively coupling the projector 14 to the docking device 12 may be used as desired. As a non-limiting example, the docking device 12 may be adapted to secure the projector 14 to a vehicle surface such as an interior surface of a vehicle, a vehicle console, an exterior vehicle surface, and a vehicle tailgate. As shown, the docking device 12 is further adapted to provide electrical communication between the projector 14 and at least one of a plurality of secondary devices 15. It is understood that each of the secondary devices 15 may be a source of electrical power, a source of multimedia video input data, and an audio output system, for example. It is further understood that the docking device 12 may include docking inputs 17 such as USB, mini USB, micro USB, Firewire, Bluetooth, and WiFi, for example.

The projector 14 includes an output 16 for projecting a video image. As a non-limiting example, the projector 14 is one of a miniature Light Emitting Diode (LED) projection system, a miniature Digital Light Processor (DLP) projection system, and a laser-based projection system. Other projectors may be used, as appropriate. The projector 14 is adapted to be coupled to the docking device 12. It is understood that any conventional means of selectively coupling the projector 14 to the docking device 12 may be used as desired. In certain embodiments, the projector 14 may include a memory device 19 such as a hard disk, a flash device, and other solid-state memory, for example. It is understood that the memory device 19 may be adapted to store multimedia information such as video data and audio data, for example. In other embodiments, the projector 14 may include a plurality of projector inputs 22 adapted to receive multimedia information such as USB, mini USB, micro USB, Firewire, Bluetooth, and WiFi, for example. It is understood that the projector inputs 22 may be in data communication with the memory device 19 of the projector 14, whereby multimedia data and information may be uploaded to or downloaded from the memory device 19.

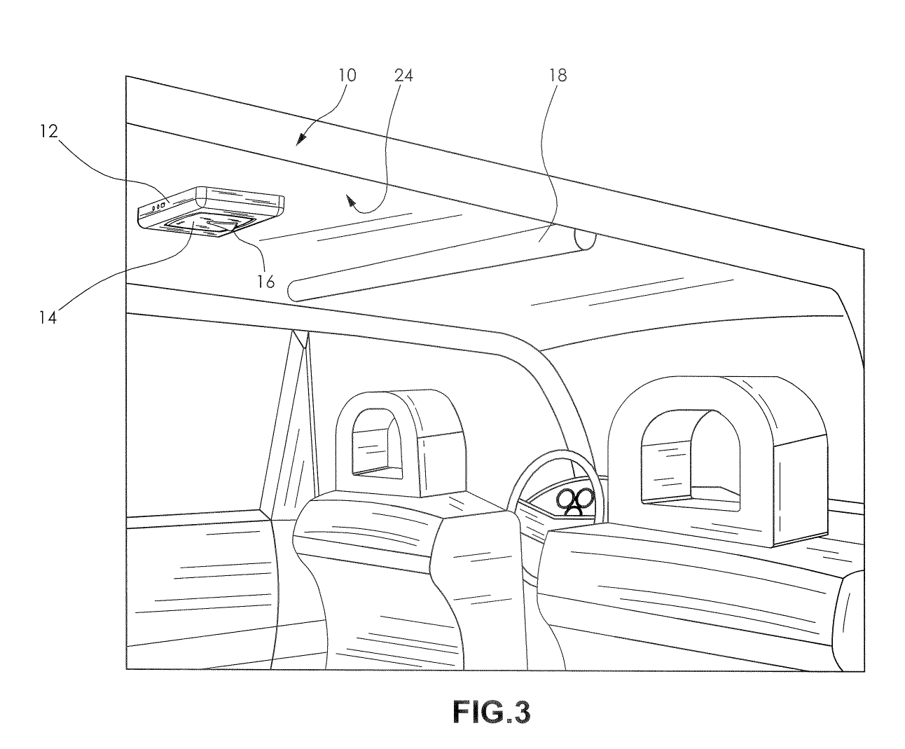

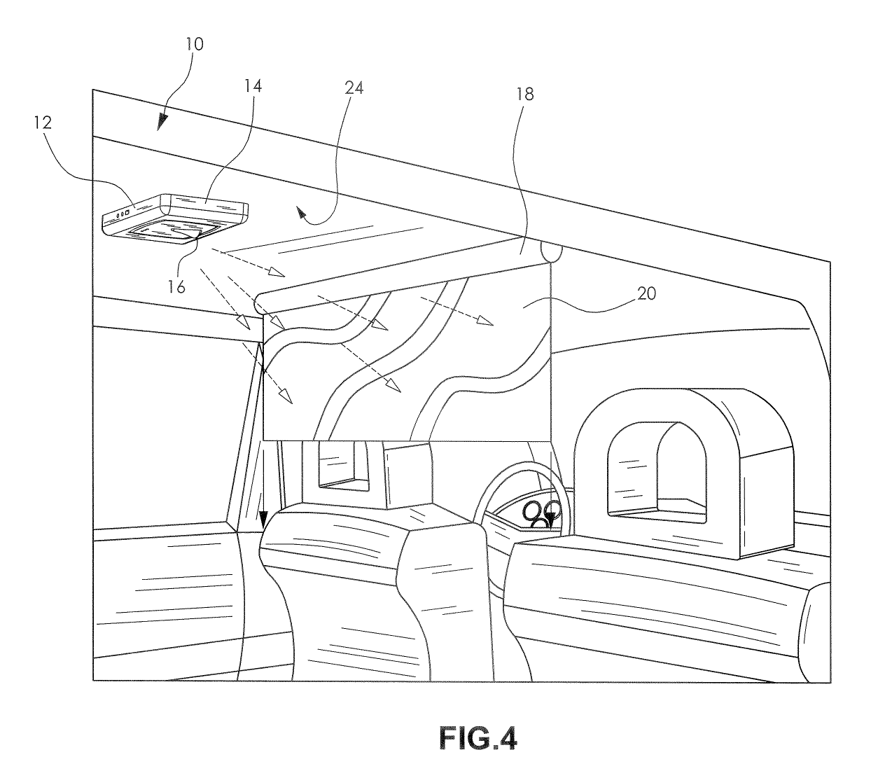

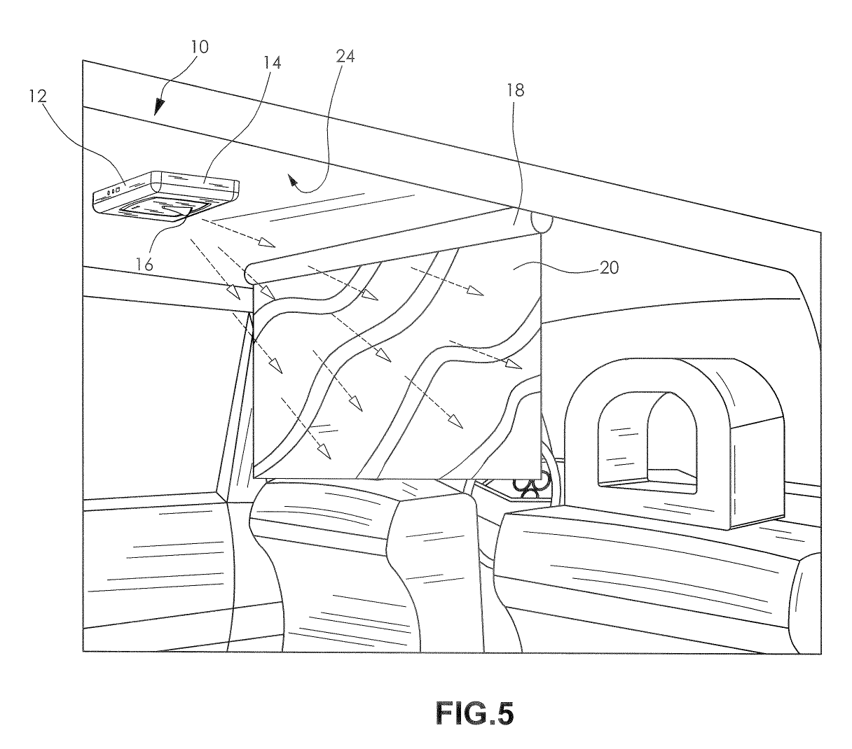

FIGS. 3, 4, and 5 show the projector system 10 in cooperation with a retracting device 18 having a viewing screen 20 according to an embodiment of the present invention. The retractable device 18 is adapted to be coupled to a desired vehicle surface. As shown, the retracting device 18 is coupled to the interior ceiling surface 24 of a vehicle. It is understood that the retracting device 18 may be coupled to other vehicle surfaces, as desired. The retracting device 18 is adapted to store the viewing screen 20. The viewing screen 20 may be extracted from the retracting device 18 and locked into a pre-determined extended position, as shown in FIG. 5. When the viewing screen 20 is not in use, the retracting device 18 retracts the viewing screen 20 into a storage position, as shown in FIG. 3. Where the retracting device 18 is mounted to a surface that is above a user, the viewing screen 20 may be extended downward. Where the retracting device 18 is mounted in such a manner that the viewing screen 20 is extended upward, a locking device (not shown) may be used to secure the viewing screen 20 in the extended position. It is understood that the retracting device 18 may be adapted to retract and extend the viewing screen 20 by any conventional means, as desired. It is further understood that the viewing screen 20 may be directly coupled to the desired vehicle surface without the cooperation of the retracting device 18.

The viewing screen 20 is typically formed from a flexible material suitable for displaying a projected video output. The viewing screen 20 may be directly coupled to the desired vehicle surface and extended to provide a suitable surface for the display of the projected video output. The viewing screen 20 may also be stored in the retracting device 18, wherein the viewing screen 20 is retracted into the retracting device 18 for storage and extracted from the retracting device 18 for displaying a projected video output.

In use, the docking device 12 is integrated into a vehicle surface such as the interior ceiling surface 24 of a vehicle. It is understood that any number of docking devices 12 may be used, as desired. The projector 14 is coupled to the docking device 12, wherein the docking device 12 provides electrical communication between the projector 14 and at least one of the secondary devices 15. Specifically, the docking station 12 can serve to provide electrical power to the projector 14, provide multimedia video input data, and transmit multimedia audio data to a vehicle audio system. As shown in FIGS. 3, 4, and 5, the viewing screen 20 is extracted from the retracting device 18 and set to a desired viewing position. Once the projector 14 is mounted, the projector 14 projects a video image onto the viewing screen 20. It is understood that the projector 14 may also project the video image onto other surfaces such as a vehicle seat headrest, for example. Specifically, video data is transmitted to the projector 14 from the memory device 19. It is understood that the video data may be transmitted to the projector 14 from one of the secondary devices 15. The video data is processed by the projector 14 and converted into the projected video image. Meanwhile, the docking device 12 may transmit an audio data to the vehicle audio system. The projector 14 may be disengaged from the docking device 12 as desired. It is understood that the projector 14 may be coupled to any one of a plurality of docking devices 12, thereby providing a passenger with a multimedia display in a variety of locations.

The projector system 10 provides an integrated docking system throughout the vehicle or outside the vehicle, thereby providing the passenger with a multimedia display for use in a variety of locations such as passenger seat, 2nd row seating, 3^{rd} row seating, and tail gate viewing, for example. Further, the projector system 10, including a laser-based or an LED-based projector 14, performs better over a wider temperature range than conventional LCD display technologies.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A projection system for a vehicle, the projection system comprising:
a docking device integrated with a surface of the vehicle, wherein the docking device is in electrical communication with at least one secondary device; and
a miniature LED-based projector adapted to be coupled to the docking device, wherein the docking device provides electrical communication between the projector and the secondary device.

2. The projector system according to claim 1, wherein the secondary device is one of a source of electrical power, a source of multimedia video input data, and an audio output system.

3. The projector system according to claim 1, wherein the surface of the vehicle is one of an interior surface of a vehicle, a vehicle console, an exterior vehicle surface, and a vehicle tailgate.

4. The projector system according to claim 1, wherein the miniature LED-based projector includes a memory device for storing multimedia data.

5. The projector system according to claim 1, further comprising a second docking device integrated with another surface of the vehicle, wherein the docking device is in electrical communication with at least one secondary device, the docking device adapted to receive the miniature LED-based projector and provide electrical communication between the miniature LED-based projector and the secondary device.

5. The projector system according to claim 1, further comprising a viewing screen coupled to a vehicle surface and adapted to display a projected video output of the projector.

6. The projector system according to claim 1, further comprising a retracting device coupled to a vehicle surface, the retracting device including a retractable viewing screen adapted to display a projected video output of the projector.

7. A projection system for a vehicle, the projection system comprising:
a docking device integrated with a surface of the vehicle, wherein the docking device is in electrical communication with at least one secondary device;
a projector adapted to be coupled to the docking device, wherein the docking device provides electrical communication between the projector and the secondary device; and
a viewing screen adapted to display a projected video output of the projector.

8. The projector system according to claim 7, wherein the secondary device is one of a source of electrical power, a source of multimedia video input data, and an audio output system.

9. The projector system according to claim 7, wherein the surface of the vehicle is one of an interior surface of a vehicle, a vehicle console, an exterior vehicle surface, and a vehicle tailgate.

10. The projector system according to claim 7, wherein the projector is one of a laser-based projector, a DLP-based projector, and an LED-based projector.

11. The projector system according to claim 7, wherein the projector includes a memory device for storing multimedia data.

12. The projector system according to claim 7, further comprising a second docking device integrated with another surface of the vehicle, wherein the docking device is in electrical communication with at least one secondary device, the docking device adapted to receive the projector and provide electrical communication between the projector and the secondary device.

13. The projector system according to claim 7, further comprising a retracting device coupled to a vehicle surface and adapted to extend the viewing screen for display of the projected video output of the projector and retract the viewing screen for storage.

14. A projection system for a vehicle, the projection system comprising:
a docking device integrated with a surface of the vehicle, wherein the docking device is in electrical communication with at least one secondary device;
a projector adapted to be coupled to the docking device, wherein the docking device provides electrical communication between the projector and the secondary device; and
a retracting device coupled to a vehicle surface, the retracting device including a retractable viewing screen adapted to display a projected video output of the projector.

15. The projector system according to claim 14, wherein the secondary device is one of a source of electrical power, a source of multimedia video input data, and an audio output system.

16. The projector system according to claim 14, wherein the surface of the vehicle is one of an interior surface of a vehicle, a vehicle console, an exterior vehicle surface, and a vehicle tailgate.

17. The projector system according to claim 14, wherein the projector is one of a laser-based projector, a DLP-based projector, and an LED-based projector.

18. The projector system according to claim 14, wherein the projector includes a memory device for storing multimedia data.

19. The projector system according to claim 14, wherein the projector includes at least one projector input adapted to receive data.

20. The projector system according to claim 14, further comprising a second docking device integrated with another surface of the vehicle, wherein the docking device is in electrical communication with at least one secondary device, the docking device adapted to receive the projector and provide electrical communication between the projector and the secondary device.
